(19) United States
(12) Patent Application Publication
(10) Pub. No.: US 2008/0222600 A1
(43) Pub. Date: Sep. 11, 2008

(54) APPARATUS AND METHOD FOR COMPONENT-BASED SOFTWARE DEVELOPMENT

(75) Inventors: Yoon-hee Choi, Suwon-si (KR); Kyung-sub Min, Seoul (KR); Chong-mok Park, Seoul (KR); Seon-jin Hong, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/960,836

(22) Filed: Dec. 20, 2007

(30) Foreign Application Priority Data
Mar. 8, 2007 (KR) 2007-23044

(51) Int. Cl. G06F 9/44; G06F 3/048

(52) U.S. Cl. 717/107; 715/763

(57) ABSTRACT

An apparatus and method for component-based software development, which can provide a development environment and a graphical user interface for systematically developing already prepared software based on a component. The apparatus for component-based software development includes a graphical-user-interface-providing unit to provide a graphical user interface to generate any one of a function-level component and a build-level component from source code; a user input unit to receive a user input value to generate any one of the function-level component and the build-level component; and a control unit to generate any one of the function-level component and the build-level component in accordance with the input value.

### CROSS-REFERENCE TO RELATED APPLICATION

This application claims from the benefit of Korean Patent Application No. 2007-23044, filed in the Korean Intellectual Property Office on Mar. 8, 2007, the disclosure of which is incorporated herein by reference.

### BACKGROUND OF THE INVENTION

1. Field of the Invention

Aspects of the present invention relate to an apparatus and method for component-based software development and, more particularly, to an apparatus and method for component-based software development that can provide a development environment and a graphical user interface for systematically modifying software based on components.

2. Description of the Related Art

With the appearance of digital convergence devices, diverse consumer electronics (CE) devices have been provided, and the capacity of software installed in the CE devices is increasing. One feature of digital convergence devices is that software having the same function can be used in diverse devices after slight modifications. Typically, most of the software installed in a CE device is identical to the source code. Accordingly, by using most of already developed software, and developing only new functions, the time and cost of the software development can be greatly reduced.

General software development tools support the design of a software structure by defining requirements of the software from the client's requirements and expressing the function of the software as relations between components based on the defined requirements. Software development tools support the subdivision of the components based on the designed structure and the specifying of the function in detail. Although such software development tools also support the designation of a target platform for the application, and automatic generation of a code, they have not yet been put to practical use.

Korean Patent Unexamined Publication No. 2003-0056654 discloses an apparatus and method of assembling EJB (Enterprise Java Bean) components, which includes a composite pallet module to browse EJB components, an architecture diagram editor module to visualize a generated architecture by dragging a component appearing on the composite pallet module, a new component, and a connector icon, and a component attribute editor module. However, this conventional apparatus and method cannot provide an environment in which existing software can be reused based on the component model.

### SUMMARY OF THE INVENTION

Aspects of the present invention provide an apparatus and method for component-based software development that can improve software development efficiency by providing a graphical user interface capable of managing an existing code as a function-level component and a build-level component and conveniently processing an error check, installation/removal of a component, build of a component, and so forth.

According to an aspect of the present invention, an apparatus for component-based software development is provided. The apparatus includes a graphical-user-interface-providing unit to provide a graphical user interface to generate any one of a function-level component and a build-level component from a source code; a user input unit to receive a user input value to generate any one of the function-level component and the build-level component; and a control unit to generate any one of the function-level component and the build-level component in accordance with the input value and to control the graphical user interface providing unit in response to user input from the user input unit.

According to another aspect of the present invention, a method for component-based software development is provided. The method includes providing a graphical user interface for generating any one of a function-level component and a build-level component from source code; receiving a user input value for generating any one of the function-level component and the build-level component; and generating any one of the function-level component and the build-level component in accordance with the input value.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating an apparatus for component-based software development according to an example embodiment of the present invention;

FIG. 2 is a view illustrating a graphical interface according to an example embodiment of the present invention;

FIG. 3 is a view illustrating the inputting of basic information during generation of a function-level component according to an example embodiment of the present invention;

FIG. 4 is a view illustrating the adding of a symbol of a function-level component according to an example embodiment of the present invention;

FIG. 5 is a view illustrating the adding of a sub-function-level component to a composite function-level component according to an example embodiment of the present invention;

FIG. 6 is a view illustrating a scene of a language defining a composite function-level component according to an example embodiment of the present invention;

FIG. 7 is a view illustrating the inputting of basic information of a language defining an interface of a function-level component according to an example embodiment of the present invention;

FIG. 8 is a view illustrating the preparing of a language defining an interface of a function-level component according to an example embodiment of the present invention;

FIG. 9 is a view illustrating the adding of a header file for preparing a language that defines an interface of a function-level component according to an example embodiment of the present invention;

FIG. 10 is a view illustrating the selecting of a symbol from the result of analyzing a header file as shown in FIG. 9;

FIG. 11 is a view illustrating the displaying of a language defining an interface of a function-level component in the form of a text in accordance with a selected symbol as illustrated in FIG. 10;

FIG. 12 is a view illustrating the inputting of basic information of a build-level component according to an example embodiment of the present invention;

FIG. 13 is a view illustrating the selecting of a root directory of a source that is an object of a build-level component according to an example embodiment of the present invention;

FIG. 14 is a view illustrating the selecting of a directory for making a build-level component according to an example embodiment of the present invention;

FIG. 15 is a view illustrating the selecting of the uppermost build file required when a build-level component is made according to an example embodiment of the present invention;

FIG. 16 is a view illustrating the selecting of a library and a header file required when a build-level component is made according to an example embodiment of the present invention;

FIG. 17 is a view illustrating the selecting of a build action required when a build-level component is made according to an example embodiment of the present invention;

FIG. 18 is a view illustrating the defining of a set interface for a build-level component according to an example embodiment of the present invention;

FIG. 19 is a view illustrating the defining of a cross-level configuration according to an example embodiment of the present invention;

FIG. 20 is a view illustrating the performing of a build test according to an example embodiment of the present invention;

FIG. 21 is a view illustrating the inputting of basic information of a composite build-level component according to an example embodiment of the present invention;

FIG. 22 is a view illustrating the assembling of a sub-build-level component of a composite build-level component according to an example embodiment of the present invention;

FIG. 23 is a view illustrating the mapping of directories of a sub-build-level component according to an example embodiment of the present invention;

FIG. 24 is a view illustrating the mapping of a set interface variable when a composite build-level component is made according to an example embodiment of the present invention;

FIG. 25 is a view illustrating the mapping of an interface in the unit of a variable value when a composite build-level component is made according to an example embodiment of the present invention;

FIG. 26 is a view illustrating the mapping of a build-level component on a function-level component according to an example embodiment of the present invention;

FIG. 27 is a view illustrating the setting of a variable of a composite build-level component according to an example embodiment of the present invention;

FIG. 28 is a view illustrating the displaying of an error occurring in a build process according to an example embodiment of the present invention;

FIGS. 29 to 31 are views illustrating the resolving of symbol collision errors according to an example embodiment of the present invention;

FIG. 32 is a view illustrating the search for a build-level component from a function-level component according to an example embodiment of the present invention;

FIG. 33 is a view illustrating the search for a function-level component from an interface according to an example embodiment of the present invention;

FIG. 34 is a view illustrating the search for a function-level component from a build-level component according to an example embodiment of the present invention;

FIG. 35 is a view illustrating the registering and installing of a component according to an example embodiment of the present invention;

FIG. 36 is a view illustrating a process of generating a function-level component according to an example embodiment of the present invention;

FIG. 37 is a view illustrating a process of generating a build-level component according to an example embodiment of the present invention; and

FIG. 38 is a view illustrating a process of generating a composite build-level component according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

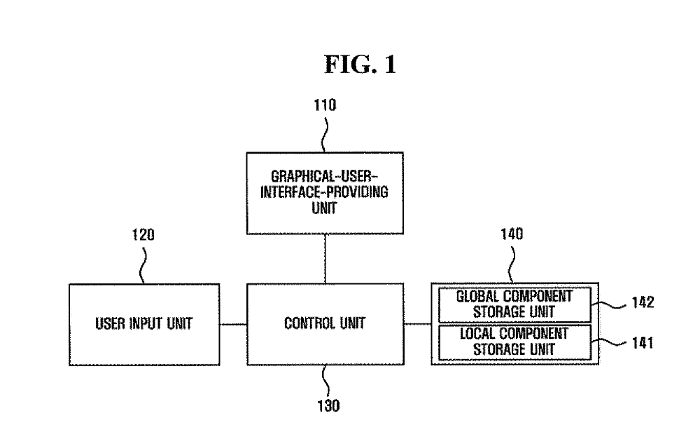

FIG. 1 is a view illustrating an apparatus for component-based software development according to an embodiment of the present invention. The apparatus 100 includes a graphical user interface (GUI) providing unit 110, a user input unit 120, a control unit 130, and a component storage unit 140. The user input 120 may be a mouse, a keyboard, a touchpad, a microphone, or other device capable of receiving input from a user. According to other aspects of the invention, the apparatus 100 may include additional and/or different units. Similarly, the functionality of one or more units may be incorporated into a single component.

The graphical user interface (GUI) providing unit 110 provides a graphical user interface (GUI) for a user to generate any one of a function-level component and a build-level component from source code. Thus, the graphical user interface providing unit allows the user to generate both functional-level components and build-level components, only functional-level components, or only basic-level components. The graphical user interface (GUI) providing unit 110 provides a graphical user interface (GUI) for generating a composite function-level component including at least one function-level component and a composite build-level component including at least one build-level component (to be described later).

A function level component is a software component that expresses a logical function of a component and provides a plurality of interfaces corresponding to a unit for providing a logical function. Since it is possible to implement the same logical function through various algorithms, one function-level component can be implemented by several build-level components. Similarly, since a build-level component is constructed in the unit of a build file defined in source code, one build-level component can implement several function-level components. The build-level component is a physically expressed software component that includes source files (containing source code) and libraries constituting the component, and build scripts required to build the source files and libraries with diverse settings. The build-level component provides a set interface and a build interface for easy application of the setting and building.

The set interface is an interface capable of changing the setting of the build-level component, and can change the construction of the component at build time by setting the value of a variable through the set interface. The build interface serves to execute a build action of the component. Build actions provided by the build-level component are generally called a build interface.

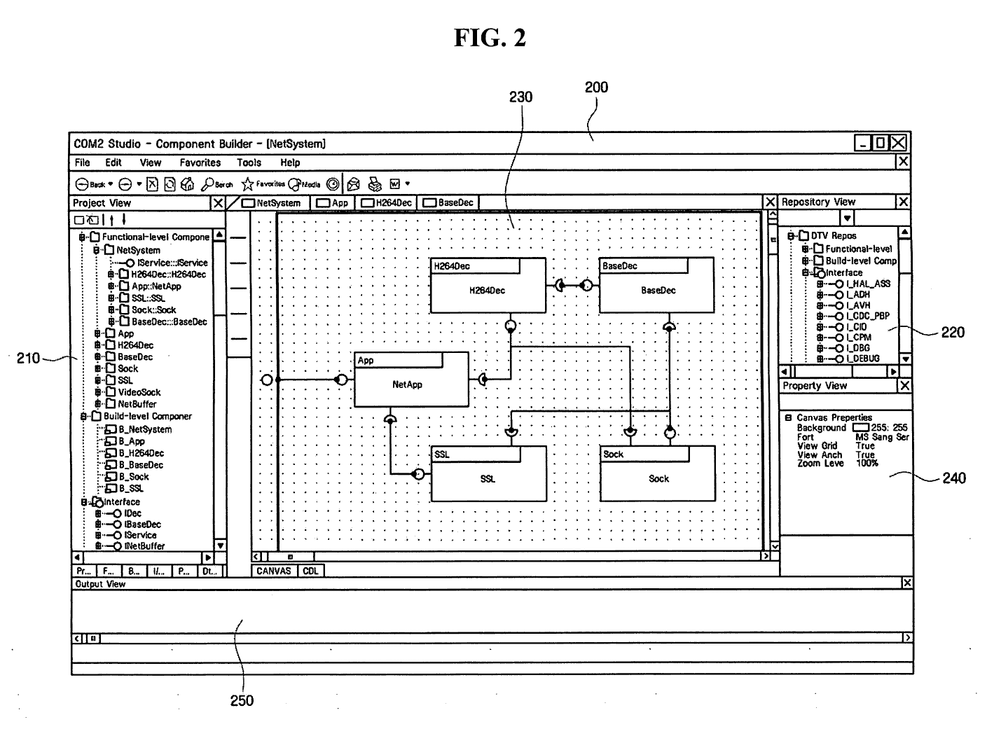

A graphical user interface (GUI) 200 provided by the graphical user interface (GUI) providing unit 110, as illustrated in FIG. 2, includes a first region 210 displaying information on a project presently working, a second region 220 displaying elements stored in a global component storage unit 142, a third region 230 generating and assembling the function-level component, a fourth region 240 displaying an attribute of an element selected in the graphical user interface 220, and a fifth region 250 displaying various kinds of messages, such as an error message and so on, generated in a build process. The regions may be located in any part of the graphical user interface 200. For example, although the first region 210 is shown in FIG. 2 on the right, the first region 210 may also be located at the top of the screen, the bottom of the screen, or on the left. Similarly, the regions may be included in one window, as shown in FIG. 2, or may be located in separate windows.

The first region 210 is a region displaying information on the current project. The first region 210 includes a project pane, a function-level component pane, a build-level component pane, an interface pane, a package pane, a directory pane, and so forth. The respective panes included in the first region 210 display elements stored in the local component storage unit 141, and other panes except for the project pane display elements represented by the respective names. In addition, the project pane serves to display all elements of a local component storage unit 141 in the form of a tree in one window. The user can arrange elements required for the component assembling in the third region 230, and assemble the function-level component through their connection.

As shown in FIG. 1, the component storage unit 140 is divided into the local component storage unit 141 and the global component storage unit 142. The local component storage unit 141 stores elements related to current projects. The global component storage unit 141 stores elements that can be commonly used in all projects.

The second region 220, in which elements stored in the global component storage unit 142 are displayed, includes a function-level component pane, a build-level component pane, an interface pane, a pane showing the search results, and so forth. The second region 200 provides a function of searching for specified elements, and particularly has functions such as searching for a function-level component implemented by a specified build-level component, searching for a build-level component implementing a specified function-level component, and searching for a function-level component including a specified interface.

The third region 230 is a region for generating and assembling the function-level component. A new component is generated in the third region 230 by assembling a function-level component, an interface, and so forth. In addition, the third region 230 displays errors and so on occurring in the component generating process visually (such as by different colored lines or shapes) or in text form. The fourth region 240 displays an attribute of an element selected through the graphical user interface 200, and provides a function of editing the attribute of the selected element.

As described above, through the graphical user interface (GUI) 200 provided by the graphical user interface (GUI) providing unit 110, the user can input values via the user input unit 120 in order to generate a function-level component, a build-level component, a composite function-level component, and/or a composite build-level component. The composite function-level component is generated through assembling of sub-unction-level components. The composite build-level component is generated by assembling sub-build-level components.

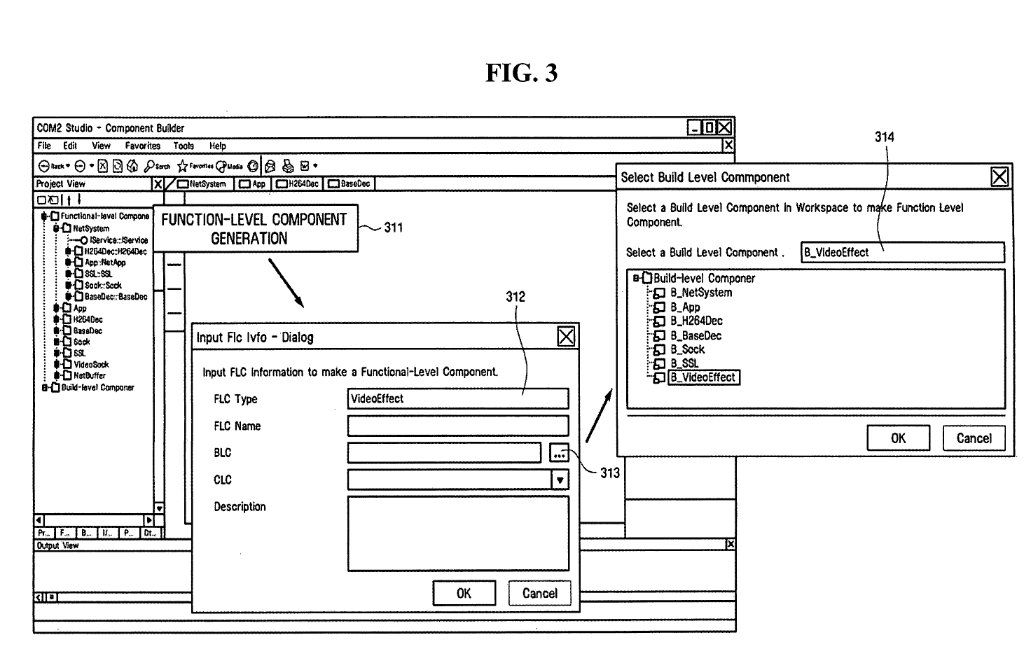

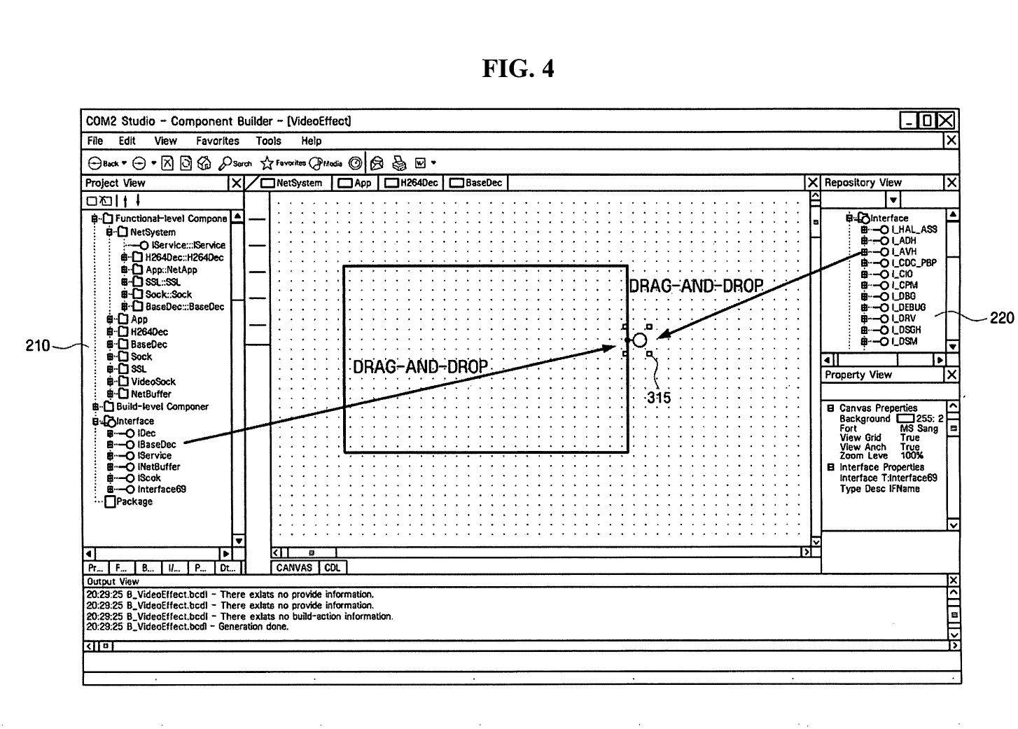

A process of generating the respective components, i.e., the function-level component, the composite function-level component, the build-level component, and the composite build-level component will be described in detail. In order to generate the function-level component, the user selects “Function-level Component Generation” through a popup menu 311 as shown in FIG. 3, and inputs basic information of the function-level component. The type of the function-level component (FLC type) 312 is inputted as the input information. If any related build-level component 314 also exists, the related build-level component 314 is selected through a manipulation of a separate button 313. If the basic information of the function-level component is inputted as shown in FIG. 3, the third region 230 for defining a new component appears as shown in FIG. 4. The user adds a new interface symbol 315 by dragging and dropping elements of the first region 210 and the second region 220 into the third region 230, and then defines the interface, as shown in FIG. 4.

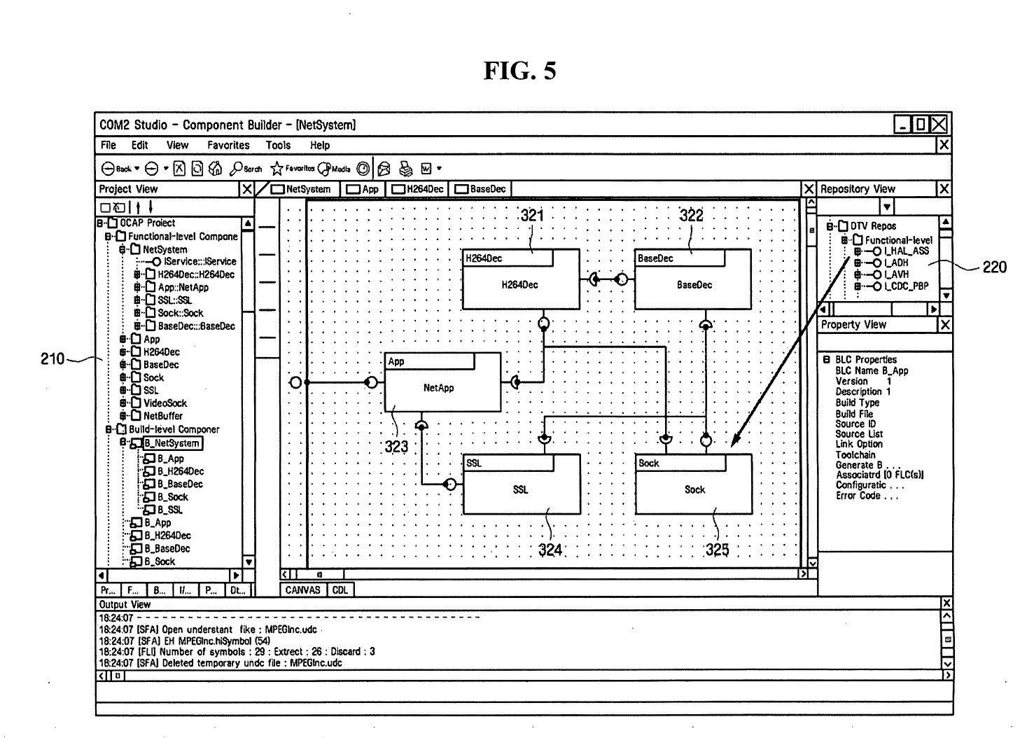

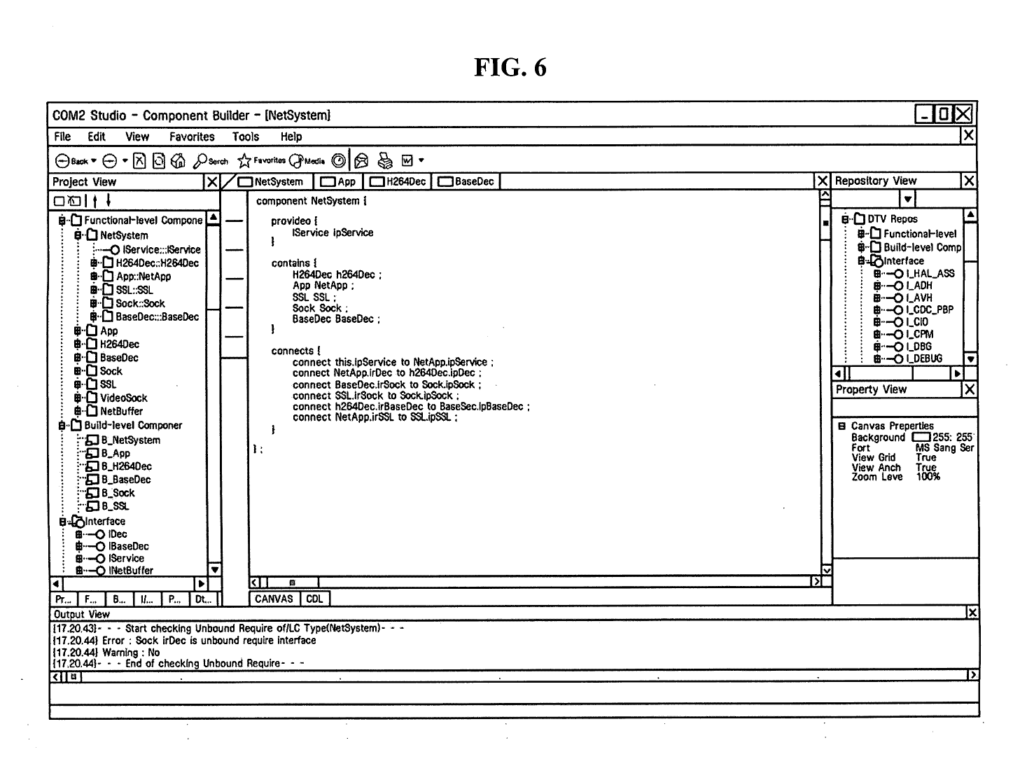

The composite function-level component is generated in a similar manner to the process of generating the function-level component. However, unlike the function-level component, another function-level component can be added to the composite function-level component as a sub-function-level component. Also, according to the composite function-level component, as shown in FIG. 5, the function-level components brought from the first region 210 and the second region 220 may be added as sub-function-level components 321, 322, 323, 324, and 325, or may be generated later using the above-described process of generating the function-level component. In addition, the respective components in FIG. 5 may be displayed in the form of a component definition language (CDL) defining the function-level component, as shown in FIG. 6.

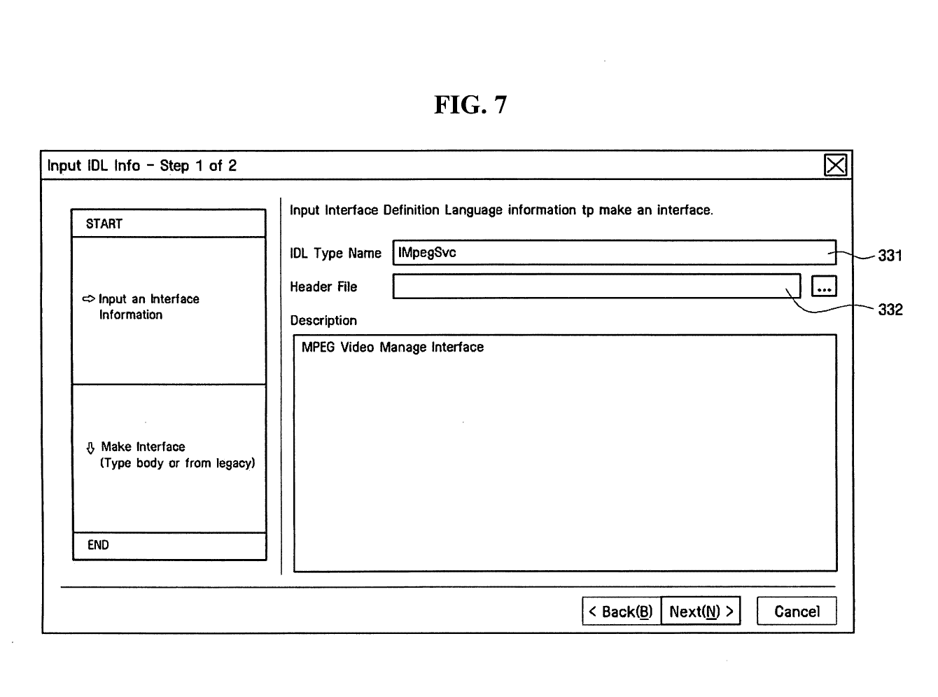

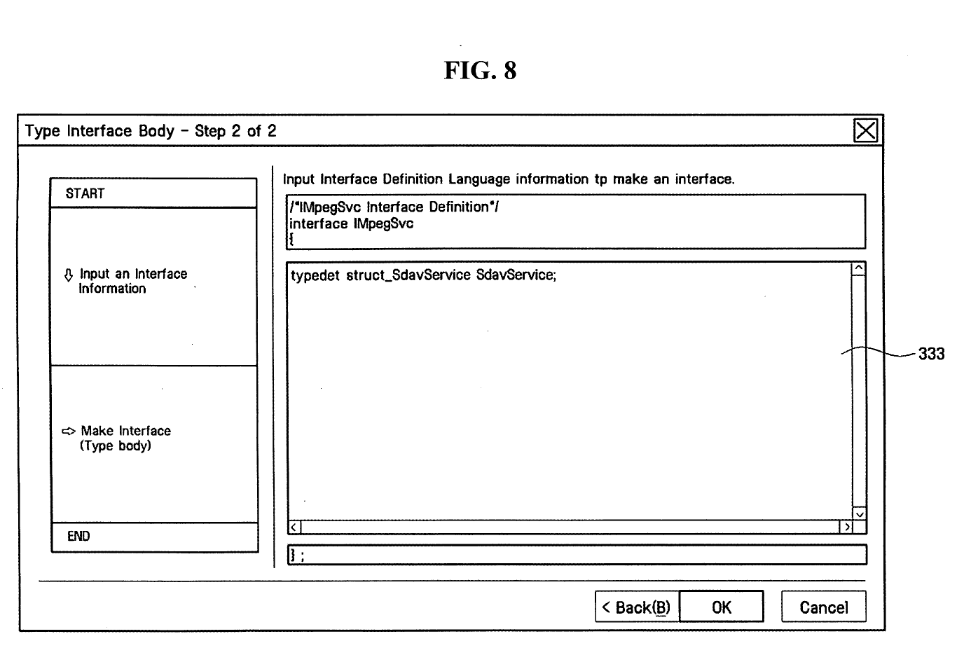

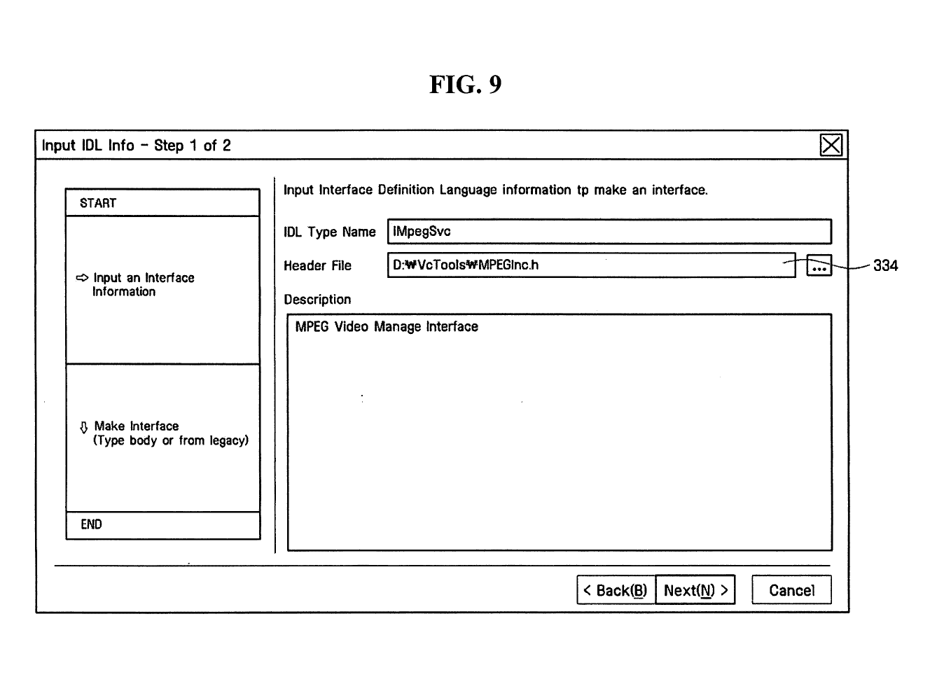

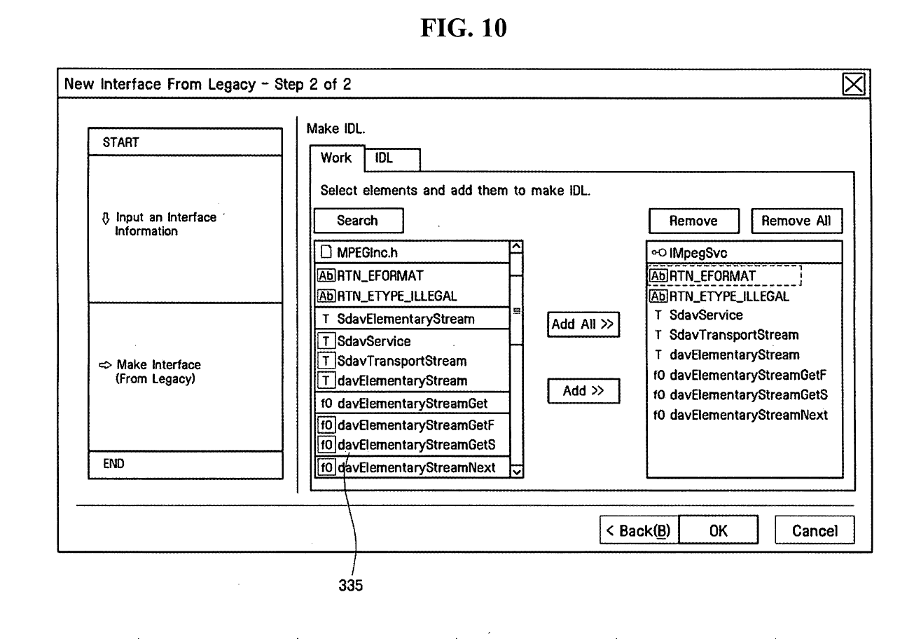

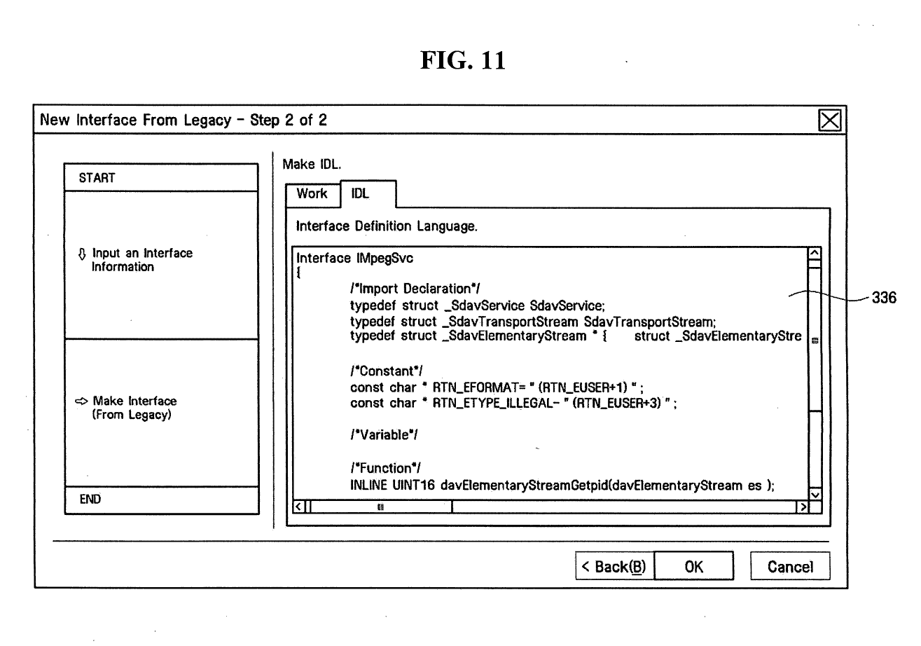

After the function-level component and the composite function-level component are generated as described above, the interface of the function level component/composite function-level component is defined. In order to define the interface, the user inputs basic information, including the type 331 of interface definition language (IDL), which is a language defining the interface of the function-level component, and an explanation 332, as shown in FIG. 7, and then directly prepares the IDL 333, as shown in FIG. 8, or designates a header file 334, as shown in FIG. 9. Accordingly an extracted symbol 335 appears through the analysis of the designated header file, as shown in FIG. 10. If the user selects only a symbol to be included in the interface, a text type IDL 336 appears, as shown in FIG. 11, so that the user can confirm the IDL 336.

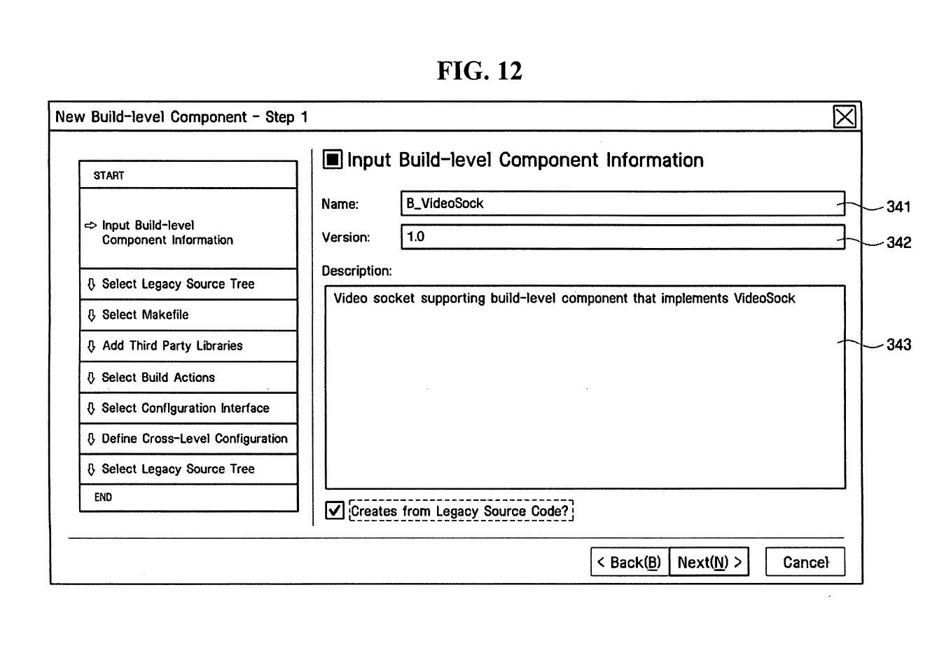

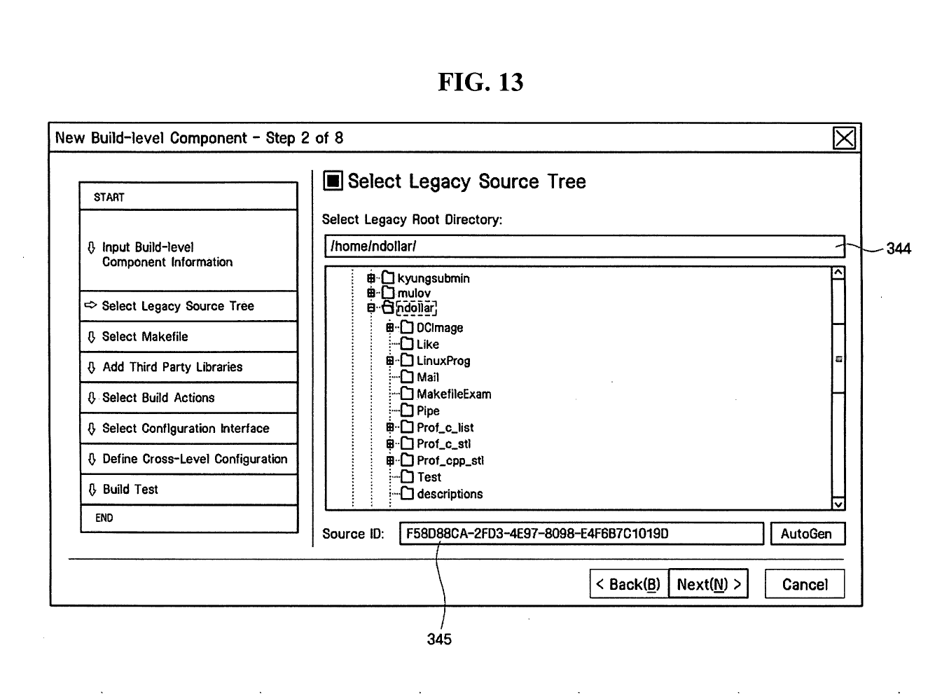

In order to generate the build-level component, the user inputs basic information including the name 341, version 342, and explanation 343 of the build-level component in the process of “Input Build-level Component Information”, as shown in FIG. 12. The user selects a root directory 344 in which the source code is located in the Select Legacy Source Tree process, as shown in FIG. 13, and inputs an ID 345 solely given to “Source ID” in order to discriminate the selected source. The input ID may be generated and input by the user or may be generated randomly.

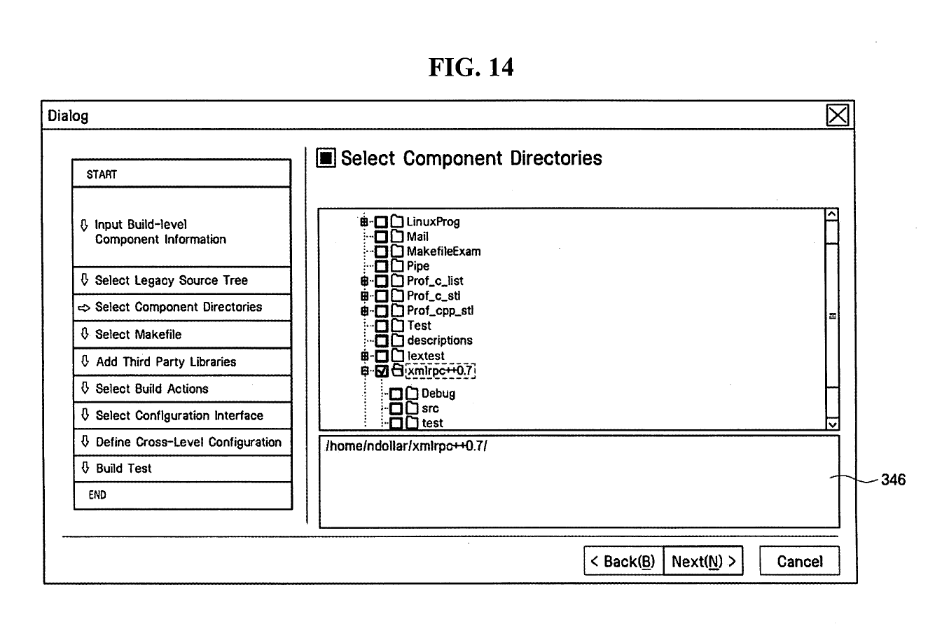

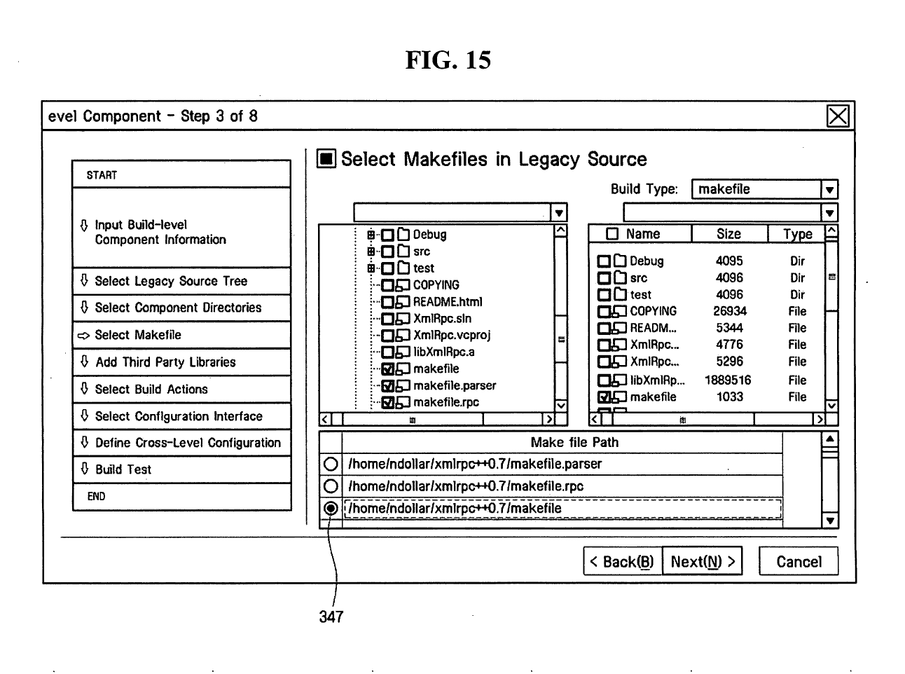

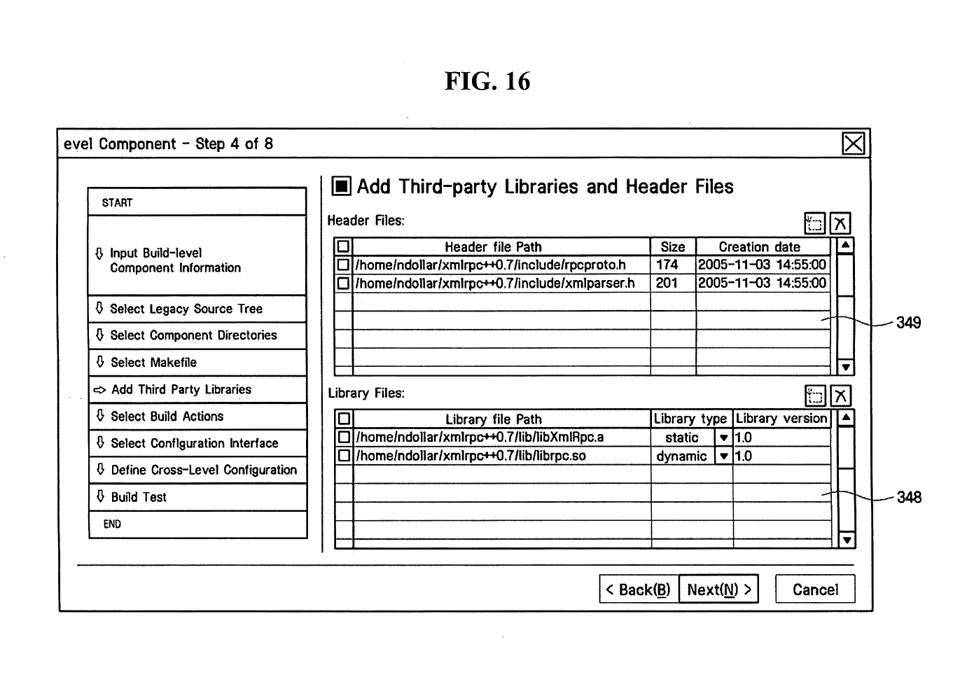

The user selects a directory 346 for making the build-level component in “Select Component Directories”, which is a lower menu of “Select Legacy Source Tree”, as shown in FIG. 14. The user extracts the uppermost build file 347 for extracting a set interface and a build interface from “Select Makefile”, as shown in FIG. 15. The user adds a third party library 348 and a header file 349 required to build the component in the “Add Third Party Libraries” menu, as shown in FIG. 16.

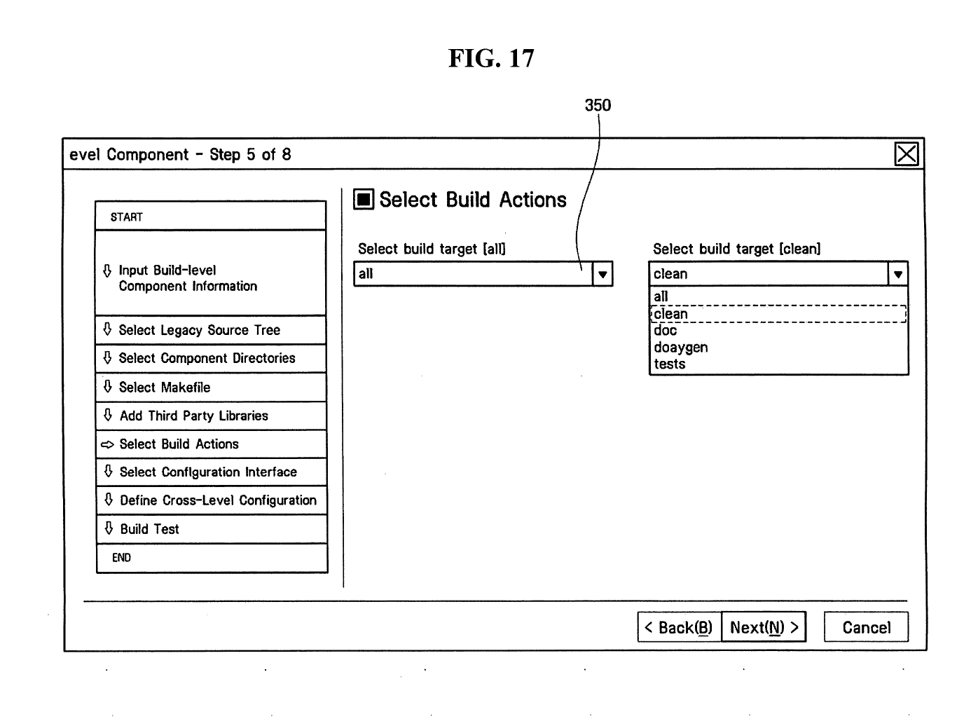

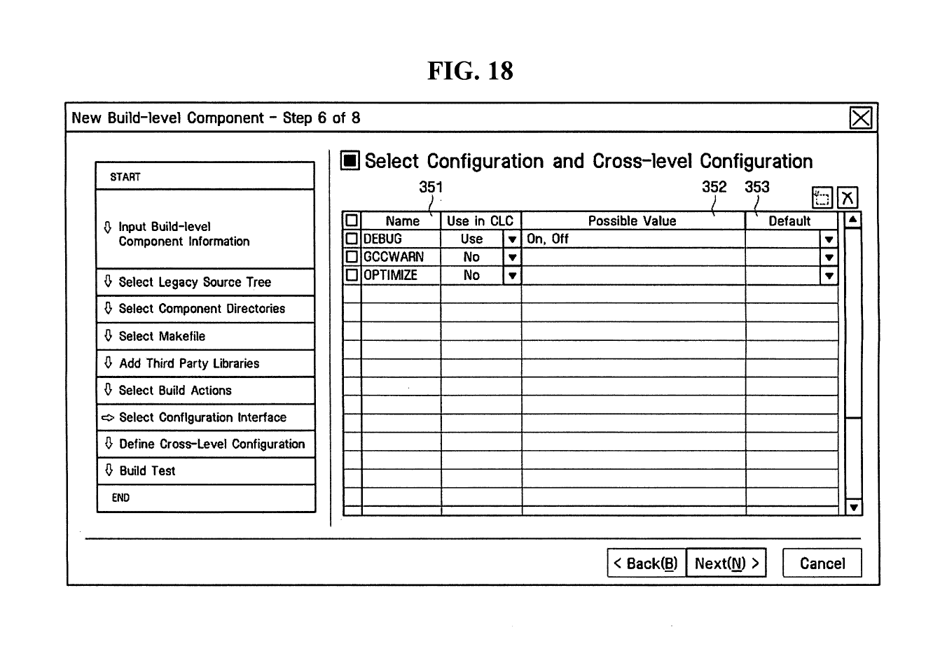

Thereafter, the user selects a build action 350 that corresponds to an “all” action for rebuilding all sources and a “clean” action for deleting all object files among build actions extracted in the build file analysis process, in a “Select Build Actions” menu as shown in FIG. 17. Information analyzed from the build file includes not only a build action but also a set variable capable of changing the setting of the source. Since only the name of the set variable is extracted, the value 352 of each variable 351, as well was a default value 353, may be designated in a “Select Configuration Interface” menu, as shown in FIG. 18.

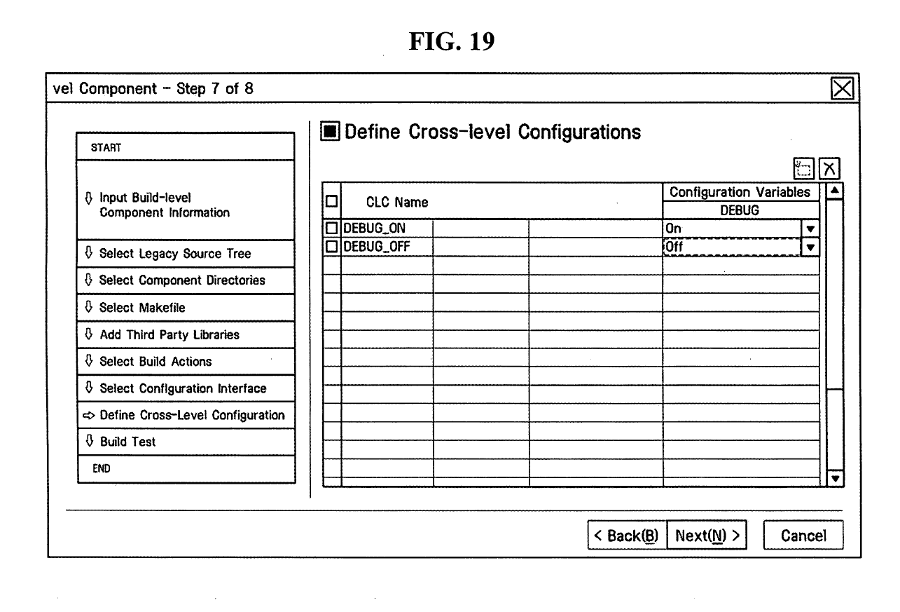

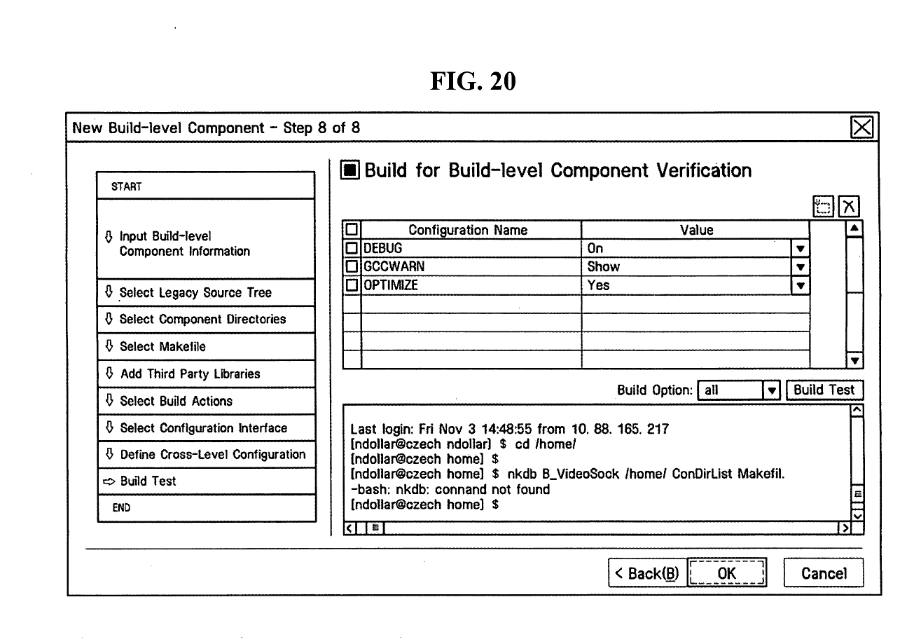

For example, if the user inputs “On, Off” in a “Possible Value” part, one of the input values may be selected as a default. In this case, the build-level component may be related to a specified function-level component if specified set variables have specified values. If the build-level component has a set of specified set variables defined as “Cross-level Configuration (CLC)”, the function provided by the specified function-level component is physically implemented. FIG. 18 explains a process of selecting what variables are used to define “Cross-level Configuration” in various configuration interfaces. In addition, it can be understood that a variable “Debug” is used to define “Cross-level Configuration” in FIG. 18. The process of defining “Cross-level Configuration” using the selected set variable in FIG. 18 may define “Cross-level Configuration” called “DEBUG_ON” and “DEBUG_OFF” using the variable “Debug”, as shown in FIG. 19. Thereafter, a “Build Test” process, which checks whether the build has been performed properly, is performed by changing the variables in the set interface, as shown in FIG. 20.

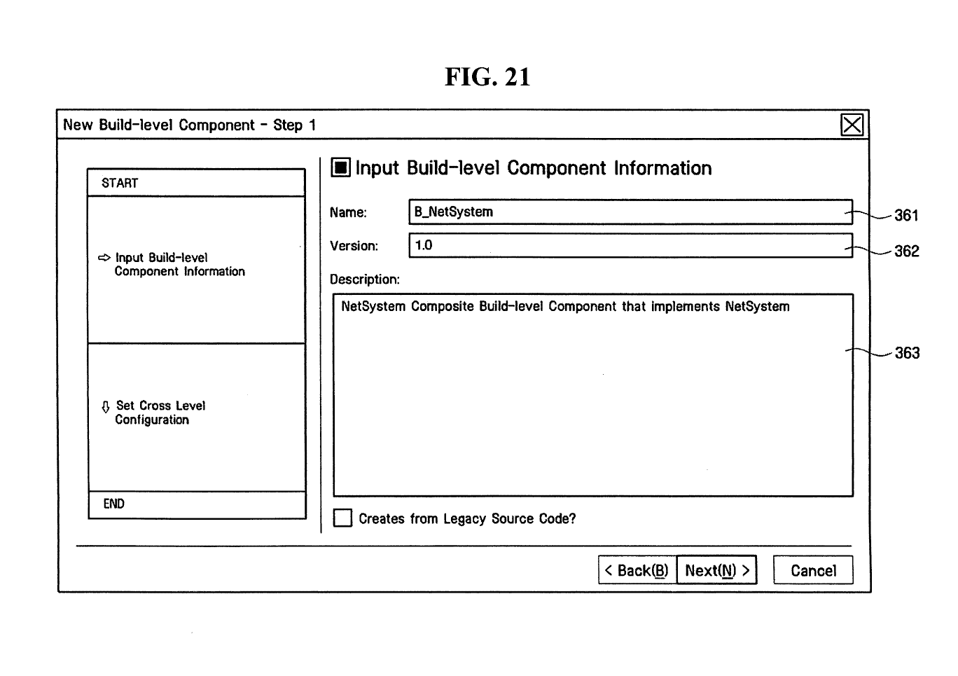

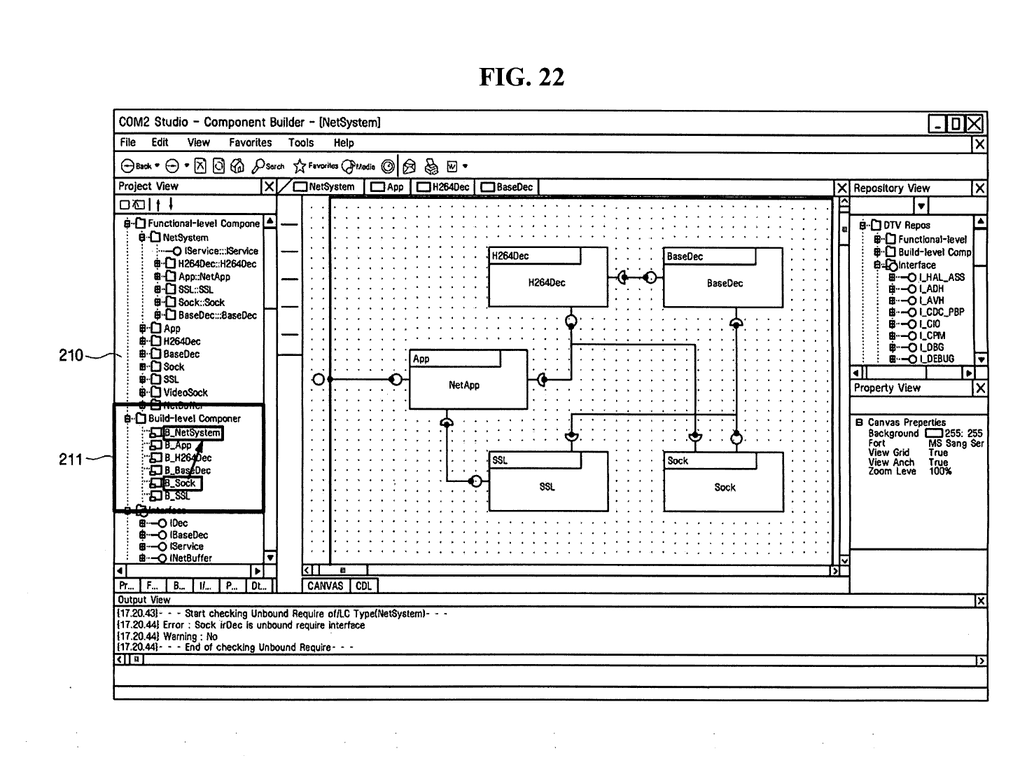

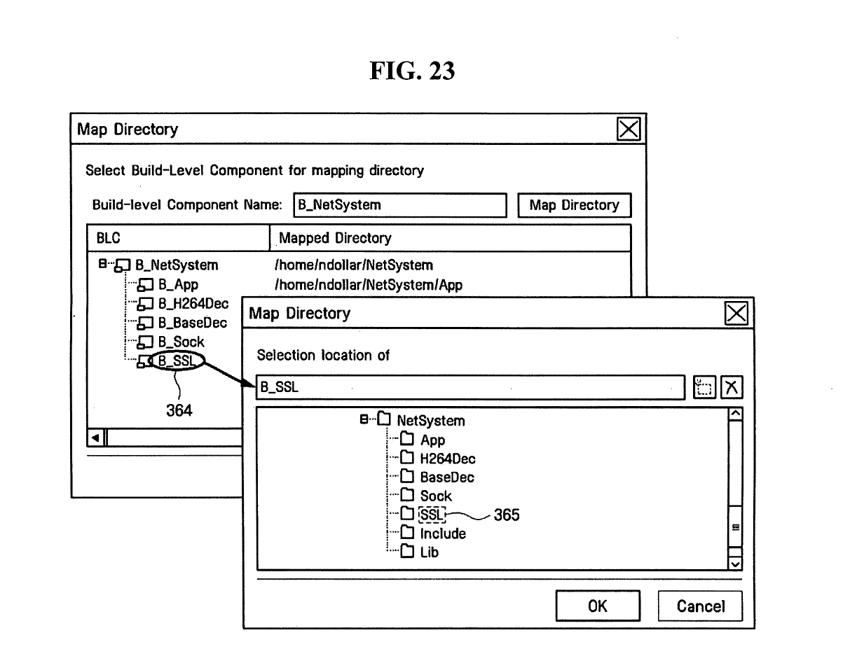

In order to generate the composite build-level component, the user inputs basic information, including the name 361, version 362, and explanation 363 of the composite build-level component, in the process of “Input Build-level Component Information”, as shown in FIG. 21. In this case, the composite build-level component 211 is generated and displayed in the first region 210 of the graphical user interface (GUI) 200, as shown in FIG. 22. Generated sub-build-level components are added through a drag-and-drop operation. As shown in FIG. 23, the physical locations of the respective sub-build-level components are mapped. FIG. 23 shows an example of selecting the directory 365 of “B_SSL” 364, which is the sub-build-level component.

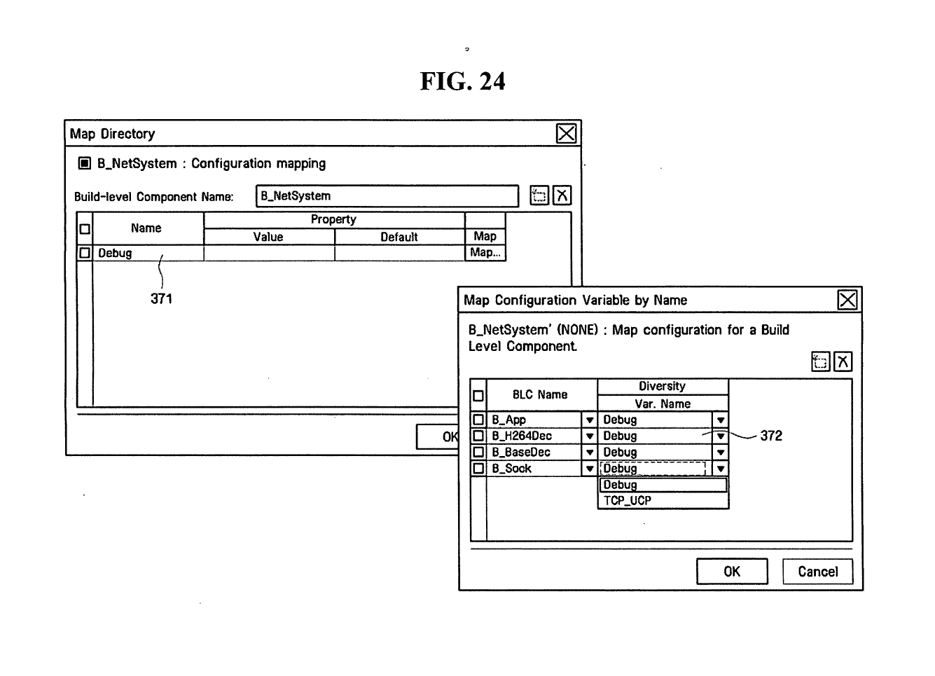

A process of mapping the set interfaces of the respective sub-build-level components is performed. If variables of the respective sub-build-level components, values that the variables can have, and defaults are as shown in Table 1, the composite build-level component “B_NetSystem” performs the mapping of the “Debug” variables to the variable values of the respective sub-build-level components as shown in Table 2. This mapping operation can be performed by defining one variable “Debug” in “B_NetSystem” and selecting the variable “Debug” having the same meaning in the sub-build-level component, as shown in FIG. 24.

TABLE 1

| Build-level Component | Variable | Variable Value | Default |
|---|---|---|---|
| B_App | Debug | On, Off | On |
| B_H264Dec | Debug | On, Off | On |
| | FrameRate | 29.97, 25 | 29.97 |
| B_Sock | Debug | On, Off | On |
| | TCP_UDP | TCP, UDP | TCP |

TABLE 2

| Build-level | | Variable | | |
|---|---|---|---|---|
| Component | Variable | Value | Contents | Default |
| B_NetSystem | Debug | On | B_App.Debug = On, | On |
| | | | B_H264Dec.Debug = On, | |
| | | | B_Sock.Debug = On | |
| | | Off | B_App.Debug = Off, | |
| | | | B_H264Dec.Debug = Off, | |
| | | | B_Sock.Debug = On | |
| | StreamType | Conn | B_H264Dec.FrameRate = 29.97 | Conn |
| | | | B_Sock.TCP_UDP = TCP | |
| | | Broad | B_H264Dec.FrameRate = 25. | |
| | | | B_Sock.TCP_UDP = UDP | |

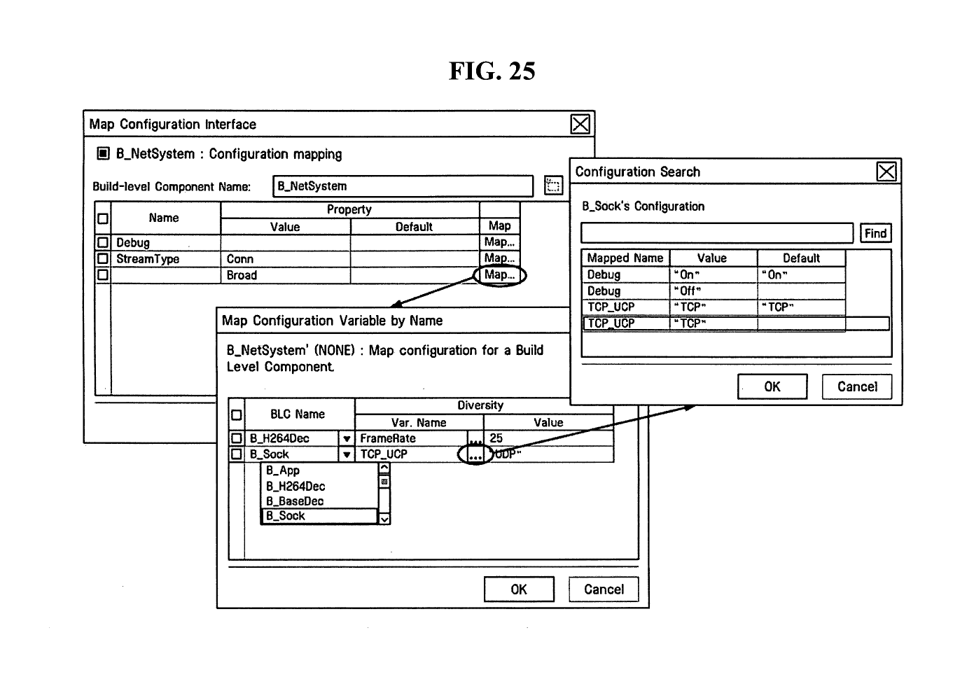

Another mapping process is the value-mapping process. As shown in Table 2, the variable “StreamType” is a variable having a new meaning, which is generated by combining different variables, such as a variable “FrameRate” of “B_H264Dec” and a variable “TCP_UDP” of “B_Sock”. That is, as shown in FIG. 25, the variable “StreamType” is defined in “B_NetSystem”, and if the value of this variable is “Conn”, it means that the variable “FrameRate” of “B_H264Dec” becomes “29.97” and the variable “TCP_UDP” of “B_Sock” becomes “TCP”. In contrast, if the value of the variable is “Broad”, it means that the variable “FrameRate” of “H_{—}264Dec” becomes “25” and the variable “TCP_UDP” of “B_Sock” becomes “UDP”. It can be understood that FIG. 25 shows an example of the case where the variable value is “Broad”.

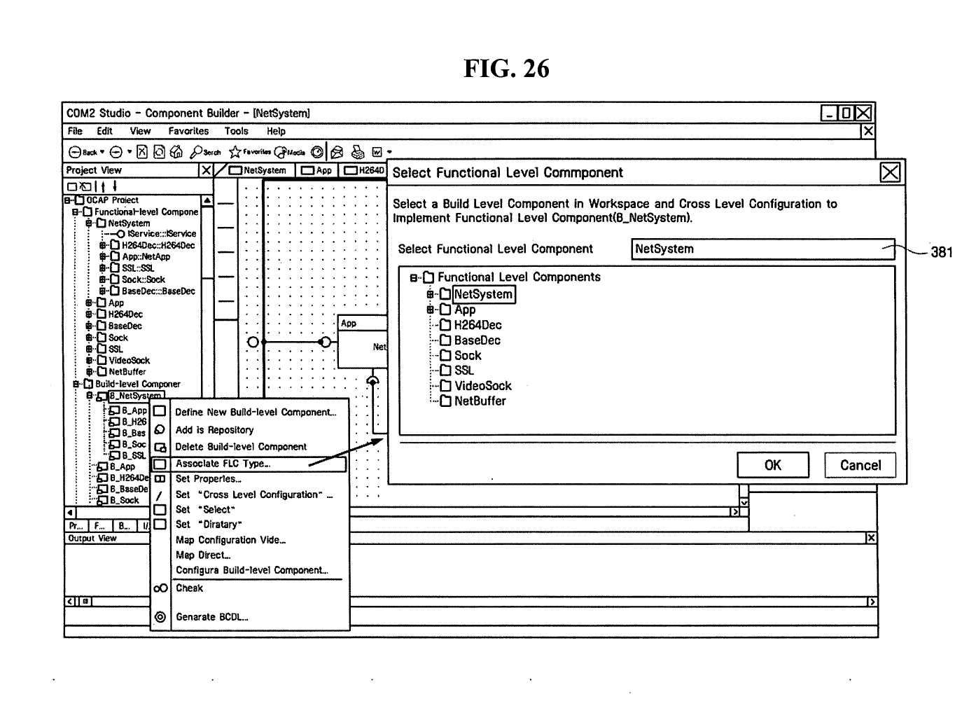

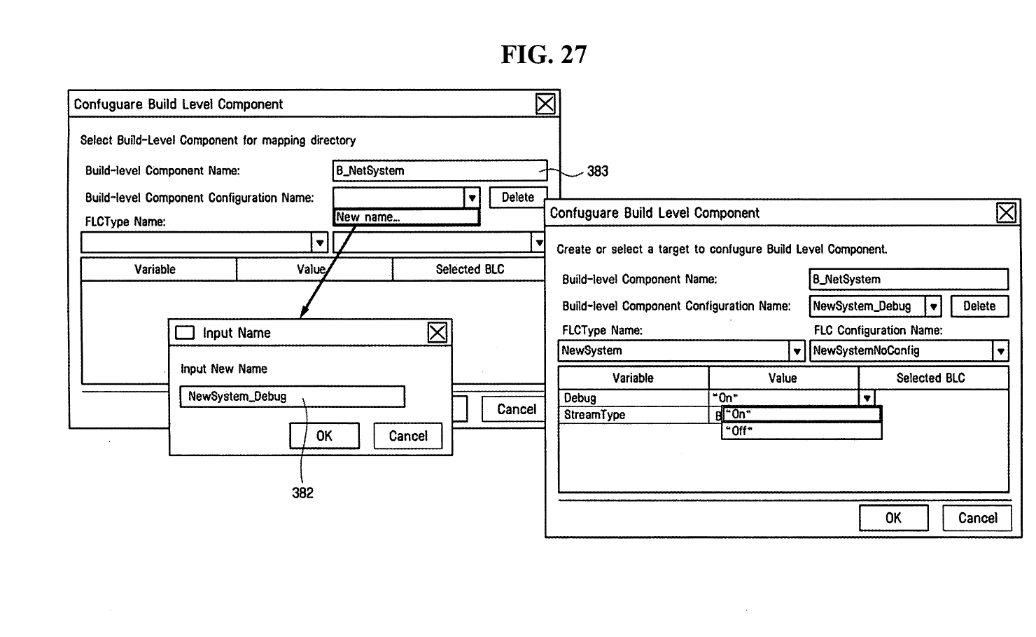

The function-level component 381 implementing the selected composite build-level component is searched for from the first region 210 and the second region 220, as shown in FIG. 26, before the composite build-level component is built. In FIG. 27, the setting of “Netsystem_Debug” 382 is defined by allocating an actual value to the set interface of the composite build-level component.

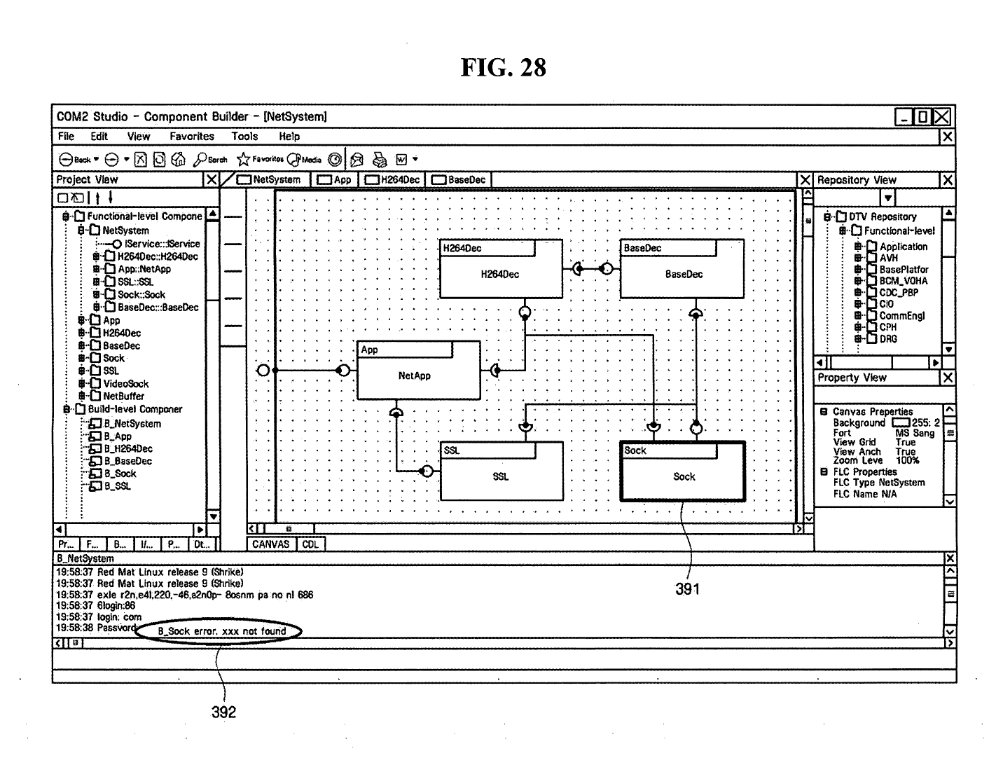

According to the setting as illustrated in FIG. 28, if the composite build-level component called “B_Netsystem” 383 is selected, the previously set item “Netsystem_Debug” 382 appears. If an error occurs in the build process, the function-level component 391 related to the corresponding component is expressed in different ways, e.g., with a different line thickness and/or a different color, so that the user can easily recognize the error occurrence, and an error message 392 is outputted through the fifth region 250.

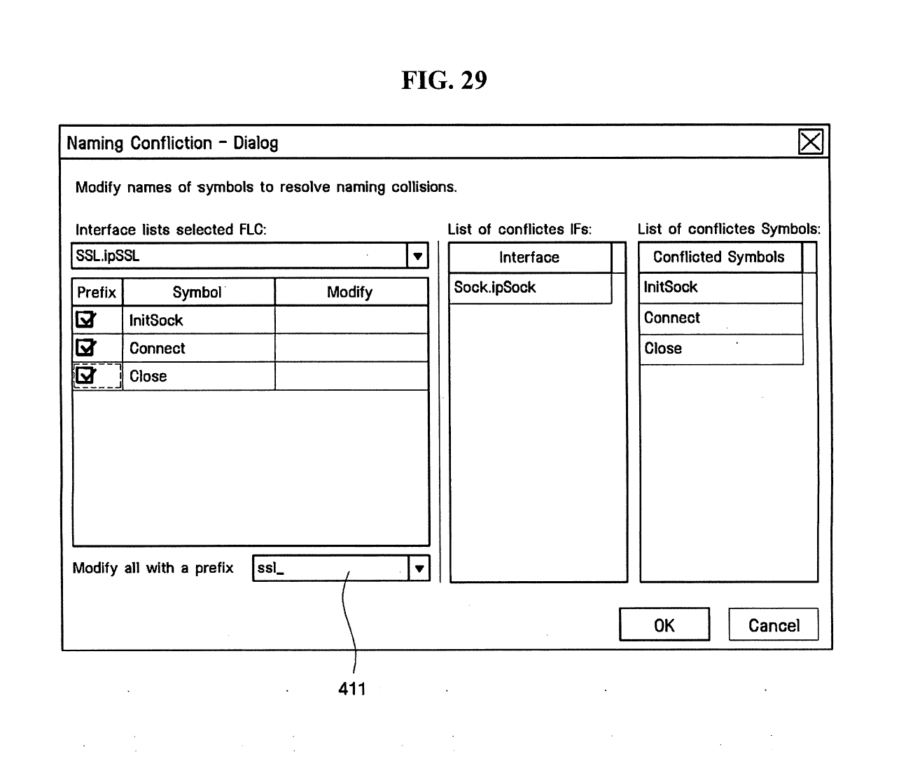

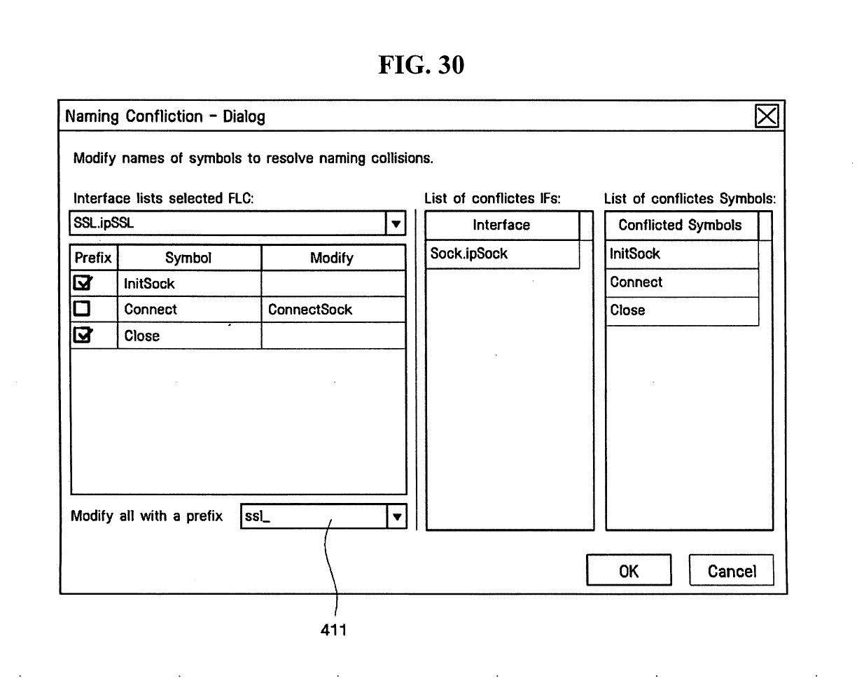

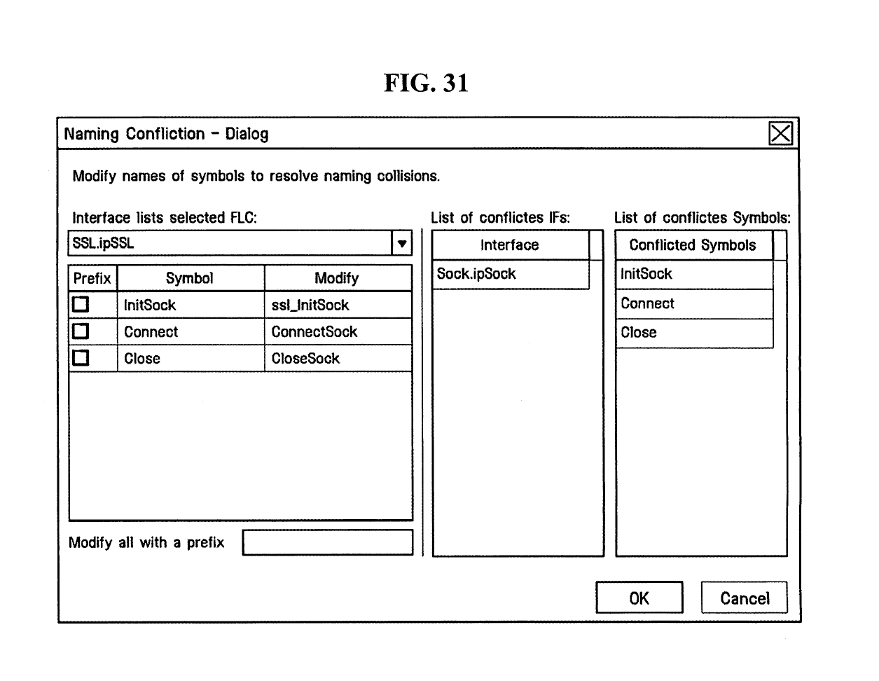

The graphical user interface (GUI) 200 indicates whether a symbol name collision has occurred, and proposes a scheme for resolving the symbol name collision. If a collision of a specified interface occurs, as shown in FIG. 29, the graphical user interface (GUI) can resolve the collision by using the same prefix 411 with respect to all the symbols, or by using a prefix with respect to a part of symbols while the user individually redefines the names of the remaining symbols, as shown in FIG. 30. Alternatively, the user may individually redefine the names of all the symbols in which the collision occurs, as shown in FIG. 31. In this case, whether to use the prefix may be determined by checking check boxes of the respective symbol names. As shown in FIG. 29, the same prefix is used with respect to all the symbols by checking the check boxes of all the symbol names. As shown in FIG. 30, the user individually redefines the unchecked “Connect” only. As shown in FIG. 31, the user individually redefines all the symbols, since a mode symbol name is not checked.

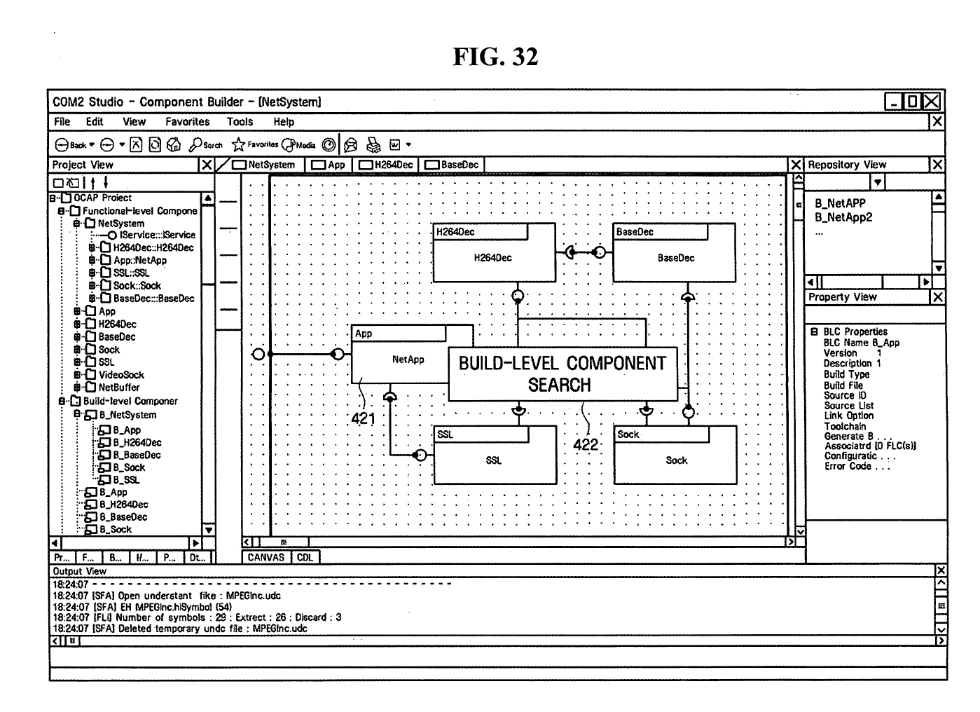

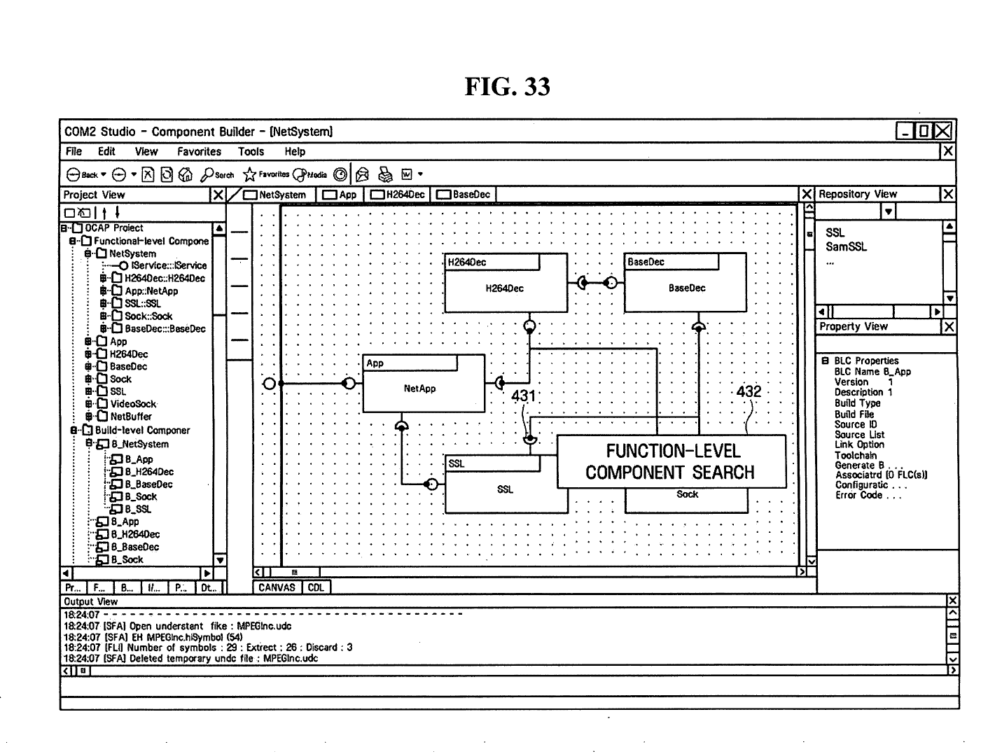

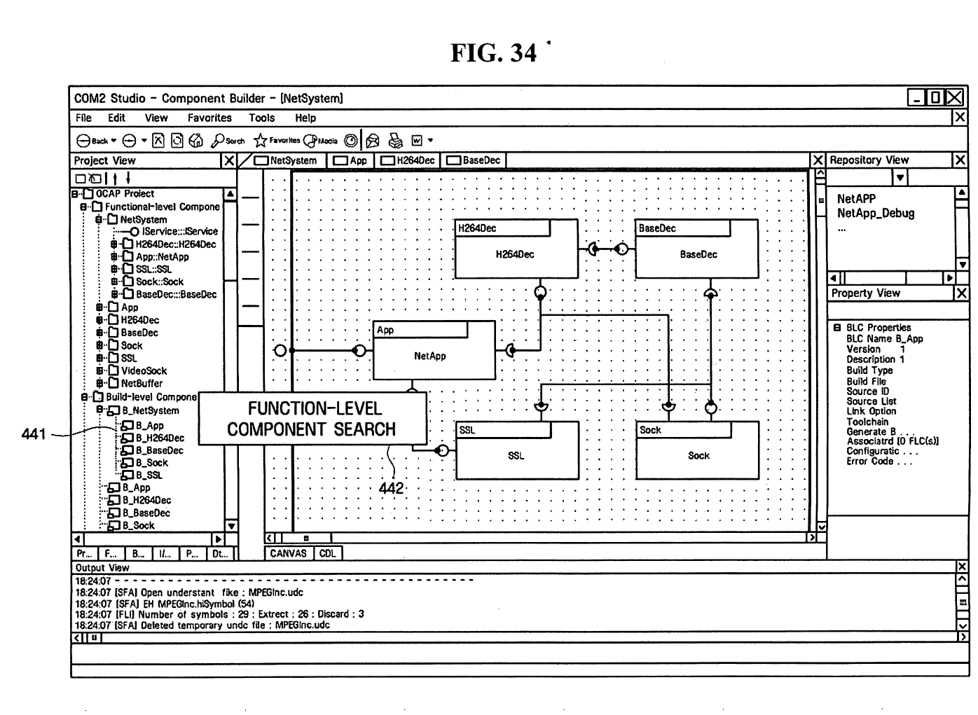

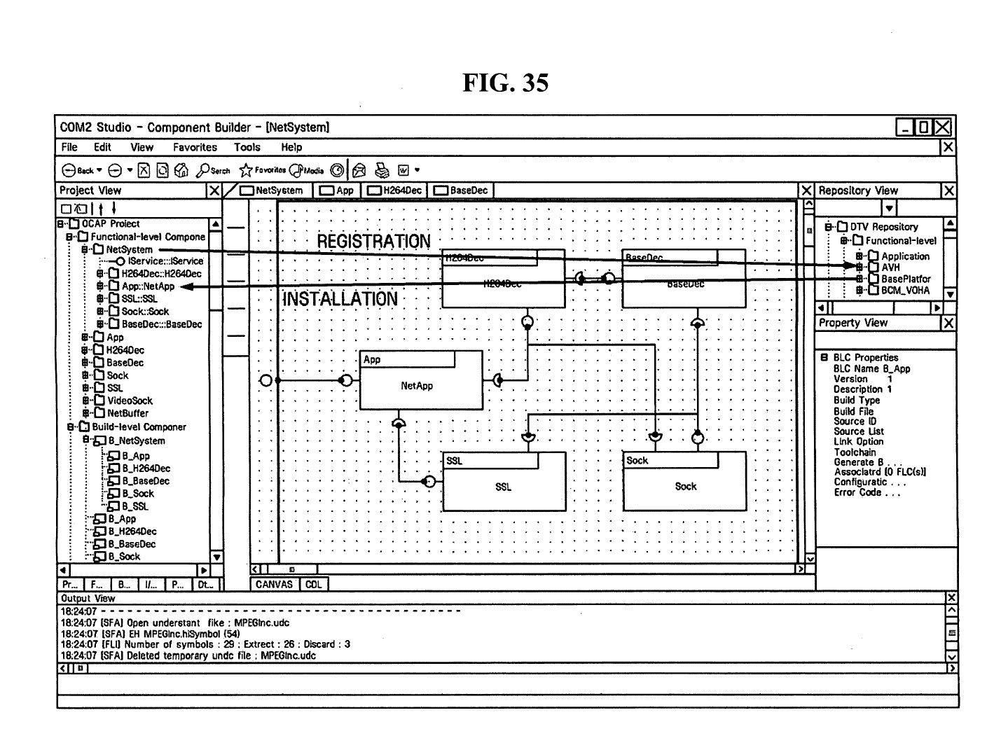

The graphical user interface (GUI) 200 may also provide a component search. The graphical user interface 200 searches for all the build-level components related to the selected function-level component 421 using a popup menu 422, as shown in FIG. 32; searches for all the function-level components 431 related to the selected interface 431 using a popup menu 432, as shown in FIG. 33; or searches for all the function-level components related to the selected build-level component 441 using a popup menu 442, as shown in FIG. 34.

The graphical user interface (GUI) 200 may also facilitate the registration and installation of the elements displayed in the first region 210 and the second region 220, i.e., the elements stored in the local component storage unit 141 and the global component storage unit 142, through the drag-and-drop action.

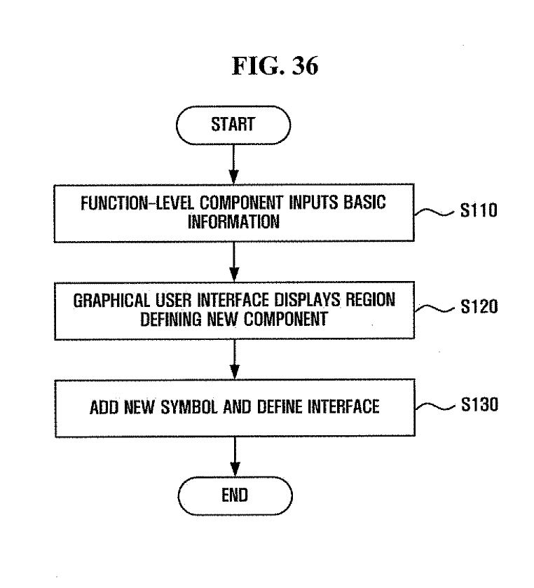

FIG. 36 is a view illustrating a process of generating a function-level component according to an embodiment of the present invention The user first inputs basic information of a function-level component to be generated through a graphical user interface 200 (GUI) at operation S110. The input basic information may include the type of the function-level component, a related build-level component, and so forth.

If the basic information of the function-level component to be generated is inputted, the graphical user interface 200 displays a third region 230 in which a new component can be defined at operation S120. The user adds a new interface symbol and defines the interface at operation S130.

Although a process of generating a function-level component is illustrated in FIG. 36, a process of generating a composite function-level component is similar to the method of generating the function-level component except that according to the method of generating the composite function-level component, other function-level components can be added as the sub-function-level components.

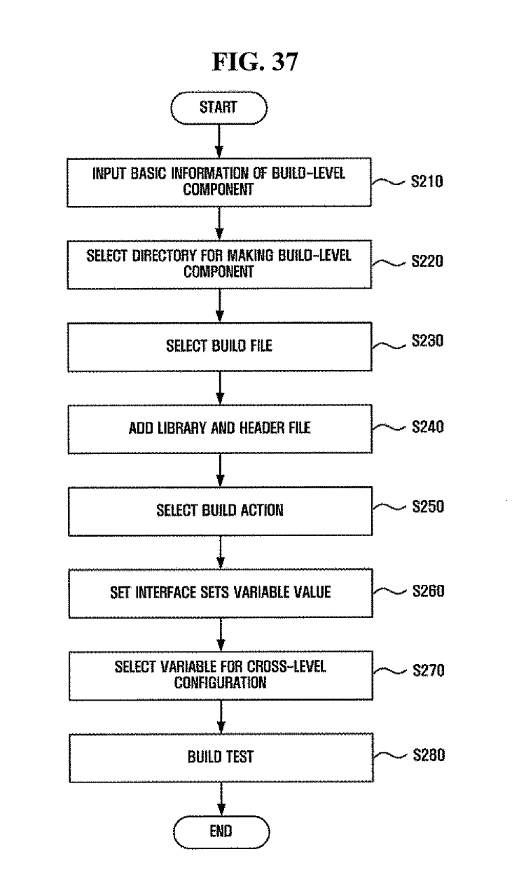

FIG. 37 is a view illustrating a process of generating a build-level component according to an embodiment of the present invention. The user first inputs basic information that includes the name, version, and explanation of a build-level component at operation S210. A scene on which the user inputs the basic information of the build-level component may be as illustrated in FIG. 12. The user selects “Create from Legacy Source Code?” of FIG. 12 when generating the build-level component from the existing source code.

After inputting the basic information of the build-level component, the user selects the root directory in which the source code is located, and selects a directory for making the build-level component from the selected root directory at operation S220. The directory for making the build-level component may be selected in a manner such that the root directory in which the source code is located is selected as shown in FIG. 13. The directory for making the build-level component among lower directories of the selected root directory may be selected, as shown in FIG. 14.

After selecting the directory for making the build-level component, the user selects the uppermost build file for extracting the set interface and the build interface at operation S230. The user adds a third-party library and a head file required to build the component at operation S240. The selection of the uppermost field file and the addition of the third library and the header file may be the same as those as described above with reference to FIGS. 15 and 16.

The user selects a build action in a build file analysis process at operation S250, and sets the variable value through the set interface at operation S260. As described above, the setting of the variable value indicates the setting of what value the respective variable has and what value is set as default 353, as shown in FIG. 18. The user selects the variable for “Cross-level Configuration”, and defines the selected variable at operation S270. If the variable for “Cross-level Configuration” is defined, the build-level component generated through a build test process is stored at operation S280.

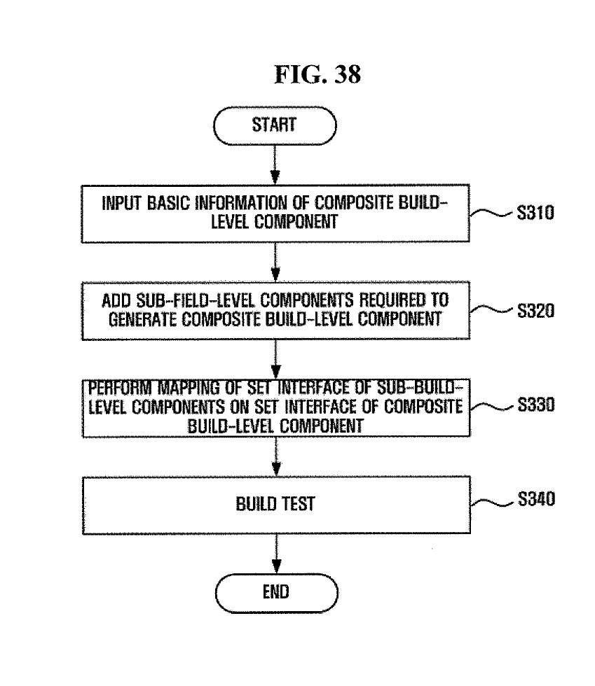

FIG. 38 is a view illustrating a process of generating a composite build-level component according to an embodiment of the present invention. The user first inputs basic information that includes the name, version, and explanation of a composite build-level component through the graphical user interface 200 at operation S310. After inputting the basic information of the composite build-level component, the user adds the build-level component required to generate the composite build-level component at operation S320. The user performs the mapping of the directories that are the physical locations of the respective sub-build-level components on the composite build-level components as shown in FIG. 23.

The set interface of the composite build-level component is mapped on the set interface of the respective sub-build-level component at operation S330. Variables of the sub-build-level component having the same meaning are mapped on the variables of the composite build-level component, or variables having different meanings are mapped on the variables of the composite build-level component. If the set interface mapping between the composite build-level component and the respective sub-build-level component is completed, the build test is performed at operation S340, and the generated composite build-level component is stored.

In addition, aspects of the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), DVDs, CD-ROMs, magnetic tapes, floppy disks, optical data storage devices, and carrier waves (such as data transmission through the Internet) The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

In the embodiment of the present invention, the term “unit”, as used herein, means, but is not limited to, a software or hardware component, such as a Field Programmable Gate Array (FPGA) or an Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units.

As described above, the apparatus and method for component-based software development according to aspects the present invention produces several effects. A graphical user interface in which components and functions such as assembling, setting, error checking, and build of the components are combined is provided to promptly develop component-based software, and thus the time required for the software development can be shortened. In addition, by expressing software as components, the software structure can be analyzed generally and in detail, so that the user can easily grasp the structure.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus for component-based software development, the apparatus comprising:
a graphical-user-interface-providing unit to provide a graphical user interface to generate any one of a function-level component and a build-level component from source code;
a user input unit to receive a user input value for generate any one of the function-level component and the build-level component; and
a control unit to generate any one of the function-level component and the build-level component in accordance with the input value and to control the graphical user interface providing unit in response to user input from the user input unit.

2. The apparatus of claim 1, wherein the graphical user interface comprises:
a first region to display local elements corresponding to a present task;
a second region to display global elements;
a third region to generate and assemble the function-level component;
a fourth region to display an attribute of a selected element; and
a fifth region to display a message related to generation of a component.

3. The apparatus of claim 1, wherein:
the user input unit receives basic information for generating the function-level component from the user; and
the graphical user interface providing unit adds a symbol corresponding to the function-level component to the graphical user interface.

4. The apparatus of claim 3, wherein a language that defines an interface of the function-level component is automatically prepared from the symbol extracted from a selected header filer.

5. The apparatus of claim 1, wherein the user input unit receives basic information for generating the build-level component from the user.

6. The apparatus of claim 5, wherein the user input unit receives input to select a directory, in which the source code for generating the build-level component is located, from the user.

7. The apparatus of claim 6, wherein the user input unit receives input to select a build file for generating the build-level component from the user.

8. The apparatus of claim 7, wherein the user input unit receives input to select a third-party library and a header from the user.

9. The apparatus of claim 8, wherein the user input unit receives input to select a build action from the user.

10. The apparatus of claim 9, wherein the user input unit receives input from the user to define a set interface for changing the setting of the build-level component and to select a variable to be used for the setting.

11. The apparatus of claim 10, wherein the control unit performs a build test by changing the value of the variable.

12. The apparatus of claim 1, wherein the user input unit receives basic information for generating a composite build-level component, in which the build-level component is assembled, from the user.

13. The apparatus of claim 12, wherein the user input unit receives input to perform a mapping of directories of sub-build-level components included in the composite build-level component from the user.

14. The apparatus of claim 13, wherein the user input unit receives input to perform a mapping of a set interface of the sub-build-level component on a set interface of the composite build-level component from the user.

15. The apparatus of claim 14, wherein the user input unit receives input from the user to perform a mapping of function-level components corresponding to the sub-build-level components.

16. The apparatus of claim 1, wherein, if a symbol name collision between the components occurs, the control unit resolves the symbol name collision through the graphical user interface.

17. The apparatus of claim 1, wherein the control unit provides a result of a search for the build-level component related to a specified function-level component through the graphical user interface.

18. The apparatus of claim 1, wherein the control unit provides a result of a search for the function-level component related to a specified interface through the graphical user interface.

19. The apparatus of claim 1, wherein the control unit provides a result of a search for the function-level component related to a specified build-level component through the graphical user interface.

20. A method of component-based software development, comprising:
providing a graphical user interface to generate any one of a function-level component and a build-level component from source code;
receiving a user input value to generate any one of the function-level component and the build-level component; and
generating any one of the function-level component and the build-level component in accordance with the input value.

21. The method of claim 20, wherein the graphical user interface comprises:
a first region to display local elements corresponding to a present task;
a second region to display global elements;
a third region to generate and assemble the function-level component;
a fourth region to display an attribute of a selected element; and
a fifth region to display a message related to a component generation.

22. The method of claim 20, wherein the inputting comprises:
inputting basic information for generating the function-level component; and
adding a symbol that corresponds to the function-level component to the graphical user interface.

23. The method of claim 22, wherein a language that defines an interface of the function-level component is automatically prepared from the symbol extracted from a selected header file.

24. The method of claim 20, wherein the receiving of user input comprises receiving basic information for generating the build-level component.

25. The method of claim 24, wherein the receiving of the user input comprises receiving input to select a directory in which the source code for generating the build-level component is located.

26. The method of claim 25, wherein the receiving of the user input comprises receiving input to select a build file for generating the build-level component.

27. The method of claim 26, wherein the receiving of the user input comprises receiving input to select a third-party library and a header.

28. The method of claim 27, wherein the receiving of the user input comprises receiving input to select a build action.

29. The method of claim 28, wherein the receiving of the user input comprises:
receiving input to define a set interface for changing the setting of the build-level component; and
receiving input to select a variable to be used for the setting.

30. The method of claim 29, wherein the generating comprises performing a build test by changing the value of the variable.

31. The method of claim 20, wherein the receiving of the user input comprises receiving basic information for generating a composite build-level component in which the build-level component is assembled.

32. The method of claim 31, wherein the receiving of the user input comprises receiving input to perform a mapping of directories of sub-build-level components included in the composite build-level component.

33. The method of claim 32, wherein the receiving of the user input comprises receiving input to perform a mapping of a set interface of the sub-build-level component on a set interface of the composite build-level component.

34. The method of claim 33, wherein the receiving of the user input comprises receiving user input to perform a mapping of function-level components corresponding to the sub-build-level components.

35. The method of claim 20, wherein the generating comprises providing the resolving the symbol name collision through the graphical user interface, if a symbol name collision occurs between the components.

36. The method of claim 20, wherein the generating comprises providing a result of a search for the build-level component related to a specified function-level component through the graphical user interface.

37. The method of claim 20, wherein the generating comprises providing a result of a search for the function-level component related to a specified interface through the graphical user interface.

38. The method of claim 20, wherein the generating comprises providing a result of a search for the function-level component related to a specified build-level component through the graphical user interface.

39. The apparatus of claim 1, further comprising:
a storage unit to store components including basic-level components and functional-level components.

40. The apparatus of claim 39, wherein the storage unit comprises:
a local component storage unit to store components relating to a current project; and
a global component storage unit to store components that can be used for any project.

41. A method of developing software using reusable components via a graphical user interface, the method comprising;
receiving basic information about a functional-level component to be generated via a graphical user interface;
displaying, on the graphical user interface, a region in which an interface for the functional-level component can be defined;
generating the functional-level component using the basic information and the interface defined via the graphical-user interface; and
recording the functional-level component in a storage medium for re-use.

42. A computer-readable medium having a program recorded thereon that, when executed by a computer, causes the computer to display a graphical user interface to develop re-usable software components, the graphical user interface comprising:
a first region to display information about a project in process;
a second region to display components that can be re-used and to permit searching for components available for re-use;
a third region to allow the user to generate components; and
a fourth region to display an attribute of a selected element.

43. The computer-readable medium of claim 42, wherein the third region displays error messages.

44. The computer-readable medium of claim 42, wherein the fourth region allows a user to define the attributes of the selected element.

45. The computer-readable medium of claim 42, wherein the second region comprises:
a functional-level component pane to display functional-level components that can be re-used;
a build-level component pane to display build-level components that can be re-used; and
a search result pane to display the results of a search.
